(19) United States
(12) Patent Application Publication
(10) Pub. No.: US 2017/0178297 A1
(43) Pub. Date: Jun. 22, 2017

(54) METHOD AND SYSTEM FOR DEHAZING NATURAL IMAGES USING COLOR-LINES

(71) Applicant: Yissum Research Development Company of The Hebrew University of Jerusalem Ltd., Jerusalem (IL)

(72) Inventor: Raanan FATTAL, Jerusalem (IL)

(21) Appl. No.: 15/118,100

(22) PCT Filed: Feb. 19, 2015
(86) PCT No.: PCT/IL2015/050195

§ 371 Date: Aug. 11, 2016

Related U.S. Application Data
(60) Provisional application No. 61/941,762, filed on Feb. 19, 2014.

(51) Int. Cl. G06T 5/00; G06T 7/90; G06T 7/11

(52) U.S. Cl. CPC G06T 5/003; G06T 7/11; G06T 7/90; G06T 2200/21; G06T 2207/10024

(57) ABSTRACT

A system and method for single-image dehazing of natural images are provided herein. Embodiments of the method may include the following steps: dividing a natural image which include haze, into a plurality of image patches, wherein the image patches are sufficiently small so that pixels of the image patches exhibit one dimensional distributions in RGB color space, denoted color-lines; generating local image formation models for the pixels of the plurality of image patches, respectively, based on a relationship between the color-lines and the haze; calculating an offset of the color-lines from origin point of the respective local image formation models, for the image patches; and estimating scene transmission of the natural image, based on the calculated offsets.

### FIELD OF THE INVENTION

Embodiments of the present invention relate generally to image processing, and more particularly to reducing haze in images of captured natural scenes.

### BACKGROUND OF THE INVENTION

Photographs of hazy scenes typically suffer from having low-contrast and offer a limited visibility of the scene. Small dust particles or liquid droplets in the air, collectively known as aerosols, scatter the light in the atmosphere. This light deflection reduces the direct scene transmission and replaces it with a layer of previously-scattered ambient light known as airlight or veiling light. Consequently, photographs taken in hazy or dusty weather conditions, and even ones taken in relatively clear days but capturing long distances, are often of low-contrast and offer a limited visibility of the scene. A similar difficulty is encountered in underwater photography.

Most image dehazing methods remove the layer of haze by recovering the direct scene radiance. These methods rely on a physical image formation model that describes the hazy image as a convex combination between the scene radiance and the atmospheric light. As will be described herein in further details, the coefficients of this linear combination correspond to the scene transmission (visibility) at each image pixel. In case of RGB images, this model consists of four unknowns per pixel, the scene radiance at each color channel and the transmission value, whereas the input image supplies only three constraints, the intensity of each channel.

In order to resolve this indeterminacy many methods require additional information about the scene, such as multiple images taken at different weather conditions or polarization angles and knowing the scene geometry. More recently, methods that alleviate these input requirements were developed. This is achieved either by relaxing the physical model, for example by seeking for an image of maximal contrast, or by introducing additional assumptions over hazy scenes. For example, one disclosure resolves the indeterminacy by assuming a local lack of correlation between the transmission and surface shading functions. While this approach is capable of providing physically-consistent estimates, it cannot be applied at regions where the two functions do not vary sufficiently. Another disclosure robustly estimate the transmission from pixels with a dark (low-intensity) color channel. This approach requires that such pixels are found across the entire image. Large regions of bright surfaces in the image bias towards under-estimated transmission.

Due to the ambiguous nature of the dehazing problem, many of the methods developed require additional data on top of the hazy image. Yet another disclosure assumes the terrain geometry is known and estimates the pose of forward-looking airborne camera in order to obtain the transmission in the scene. A user-assisted registration process, between the image and known scene geometry, is described by another publication. One disclosure removes haze effects given two or more photographs taken at different polarization angles. The polarization angle affects the magnitude of the polarized airlight and given a parameter, relating these changes to optical thickness, the polarized airlight is removed. Another disclosure estimates this parameter automatically by assuming that higher spatial-bands of the scene radiance are uncorrelated with the polarized haze. The success of the polarization-based approach depends on the extent at which the airlight is polarized in the scene. One publication estimates the scene structure from multiple images with and without haze, assuming the surface radiance remains unchanged. A later work describes a user interactive tool for removing weather effects.

A different line of work alleviates the input requirements by following various assumptions over hazy scenes. One publication assumes a constant layer of airlight and estimate its thickness, from a single image, based on an expected proportionality between the local sample mean and the standard deviation of pixel intensities which is typically encountered in natural images. In this work we derive a localized model predicting this behavior and use it for recovering spatially-varying airlight layer. The dark-object subtraction method also removes a uniform layer of haze by subtracting the color of the darkest object. This color is used as an approximation for the airlight present in the scene and it is found manually by inspecting offsets in the image histograms.

One publication automates and extends this process for multi-spectral images acquired by satellite sensors. Another publication assumes the haze contribution resides in the lower part of the image spectrum and eliminate it based on a reference haze-free image.

More recent methods extract a spatially-varying layer of haze from a single image by following more refined assumptions over the scene. One publication extracts the haze by maximizing the resulting image contrast as well as transmission smoothness. This method generates compelling images with enhanced contrast, however it may also result in a physically-invalid excessive haze removal. Another publication also promotes high image contrast yet circumvent the time-consuming optimization by computing the transmission explicitly, based on an envelope function that ensures positive output pixels.

One publication estimates the transmission based on lack-of correlation assumption between the transmission and shading functions. As explained earlier, this approach requires a sufficient variation in these functions in order to obtain a reliable transmission estimate. Another publication models the gradient distribution of the scene depth and radiance functions using heavy tail distributions and recover these functions by further assuming statistical independence between the two. Another publication generalizes the dark-object subtraction method by inferring the transmission, locally, from dark-channel pixels found within a small neighborhood. While the prior that pixels with at least one dark channel can be found nearby holds in many regions of the image, often there are large regions where only bright pixels are available. Another publication explains the effectiveness of this approach using principal component analysis and minimum volume ellipsoid approximation. Yet another publication combines the dark-channel prior with a piecewise planar prior over the scene geometry using the alpha-expansion energy minimization framework.

Another publication combines the dark-channel approach with non-parametric denoising. More recently, one publication suggested a new dark prior for image de-assumes zero minimal value, the new prior seeks for the darkest pixel average inside each ellipsoid. This assumption may also be inaccurate over pixels that correspond to bright objects.

### SUMMARY OF EMBODIMENTS OF THE INVENTION

Embodiments of the present invention provide a method and a system for single-image dehazing that relies on a generic regularity in natural images where pixels of small image patches typically exhibit a one-dimensional distribution in RGB color space, known as color-lines.

Embodiments of the present invention derive a local formation model that explains the color-lines in the context of hazy scenes and use it for recovering the scene transmission based on the lines' offset from the origin. The lack of a dominant color-line inside a patch or its lack of consistency with the formation model allows us to identify and avoid false predictions. Thus, unlike existing approaches that follow their assumptions across the entire image, our algorithm validates its hypotheses and obtains more reliable estimates where possible.

In addition, embodiments of the present invention describe a Markov random field model which is dedicated for producing complete and regularized transmission maps given noisy and scattered estimates. Unlike traditional field models that consist of local coupling, the new model is augmented with long-range connections between pixels of similar attributes. These connections allow our algorithm to properly resolve the transmission in isolated regions where nearby pixels do not offer relevant information.

An extensive evaluation of embodiments of the method of the present invention over different types of images and its comparison to state-of-the-art methods over established benchmark images shows a consistent improvement in the accuracy of the estimated scene transmission and recovered haze-free radiances.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart diagram illustrating a method in accordance with embodiments of the present invention;

FIG. 2 is a schematic block diagram of a system in accordance with embodiments of the present invention;

FIG. 3 depicts images illustrating aspects in accordance with embodiments of the present invention;

FIG. 4 depicts a graph illustrating aspects in accordance with embodiments of the present invention;

FIG. 5 depicts images illustrating aspects in accordance with embodiments of the present invention;

FIG. 6 depicts images illustrating aspects in accordance with embodiments of the present invention;

FIG. 7 depicts a graph illustrating aspects in accordance with embodiments of the present invention;

FIG. 8 depicts images illustrating aspects in accordance with embodiments of the present invention;

FIG. 9 depicts a graph illustrating aspects in accordance with embodiments of the present invention;

FIG. 10 depicts images illustrating aspects in accordance with embodiments of the present invention;

FIG. 11 depicts images illustrating aspects in accordance with embodiments of the present invention;

FIG. 12 depicts images illustrating aspects in accordance with embodiments of the present invention;

FIG. 13 depicts images illustrating aspects in accordance with embodiments of the present invention;

FIG. 14 depicts images illustrating aspects in accordance with embodiments of the present invention;

FIG. 15 depicts images illustrating aspects in accordance with embodiments of the present invention;

FIG. 16 depicts a graph illustrating aspects in accordance with embodiments of the present invention; and

FIG. 17 depicts images illustrating aspects in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention provide a method for single-image dehazing that takes advantage of a generic regularity in natural images in which pixels of small image patches typically exhibit one dimensional distributions in RGB color space, known as color lines. Embodiments of the present invention use this observation to define a local image formation model that reasons the color-lines in the context of hazy images and allows recovering the scene transmission based on the lines' offset from the origin. Moreover, the unique pixel distribution predicted by the formation model allows us to identify patches that do not exhibit proper color-lines and discard them. In contrast to existing approaches that follow their assumptions across the entire image, our algorithm validates its hypotheses and hence obtains more reliable transmission estimates where possible. The detailed description focuses on estimating the transmission accurately under the assumption that the atmospheric light vector is given.

In the last step of the algorithm, these partial estimates are interpolated and regularized into a complete transmission map using a dedicated Markov random field model. Unlike traditional field models which consist of regular coupling between nearby pixels, we augment the field model with long-range couplings. As will be demonstrated herein, this new model better resolves the transmission in isolated regions where nearby pixels do not offer relevant information.

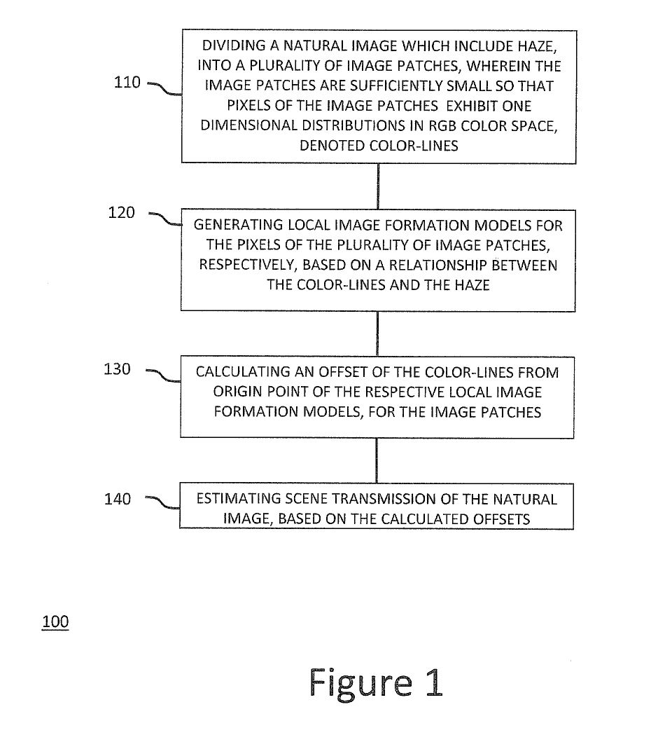

FIG. 1 depicts an image received as an input and processed image after applying the dehazing process in accordance with embodiments of the present invention. The improvement is apparent as the haze has been effectively reduced.

The results of an extensive evaluation of the method in accordance with embodiments of the present invention and its comparison to state-of-the-art techniques are reported at the end of this description. This evaluation consists of a large number of benchmark images of different quality and resolution. Various types of synthetic images were used with known ground-truth in order to analyze the method's performance at different levels of noise and haze thickness. Embodiment of the method show a consistent improvement in the accuracy at which both the scene transmission and radiance are estimated.

According to embodiments of the present invention, a new approach for dealing with haze caused by aerosols is being used. Aerosols present in the atmosphere deflect the light from its linear propagation to other directions in a process known as light scattering. Repeated scattering events across the medium reduce the visibility by creating a semi-transparent layer of ambient light, known as airlight. This physical scenario is expressed by the following image formation model:

I(x)=t(x)J(x)+(l−t(x))A (1)

where I(x) is the input image, J(x) is the scene radiance, i.e., the light reflected from its surfaces, and x=(x; y) denotes the pixel coordinates. The direct transmission of the scene radiance, t(x)J(x), corresponds to the light reflected by the surfaces in the scene and reaching the camera directly, without being scattered.

The airlight, (l−t(x))A, corresponds to the ambient light that replaces the direct scene radiance. The atmospheric light vector A describes the intensity of the ambient light. The use of a constant atmospheric light is a valid approximation when the aerosol reflectance properties as well as the dominant scene illumination are approximately uniform across the scene. RGB images are considered and hence Eq. (1) is a three-dimensional vector equation, where each coordinate corresponds to a different color channel. The scalar 0≦t(x)≦1 denotes the transmission along the camera ray at each pixel. These values correspond to the fraction of light crossing the medium, along camera rays, without being scattered. Unlike the atmospheric light A, the transmission is allowed to vary across the image and hence Eq. (1) applies to scenes of arbitrary optical depth and scattering coefficient (e.g., due to changes in aerosol density).

Many image dehazing algorithms use the image formation model in Eq. (1) to dehaze images by recovering J. This includes the recent single-image methods that perform this operation solely based on I; either by first estimating the transmission, or together with J in a joint optimization. In the description set forth below the former group of methods is followed and estimate the transmission first. Both these strategies require knowing the global atmospheric light vector A which can be estimated by various procedures. In this embodiments focus on estimating the transmission accurately and assume A is known. Finally, note that Eq. (1) assumes the input pixels values I(x) are radiometrically-linear. Thus, similarly to other methods that rely on this formation model, our method requires the reversal of the acquisition nonlinearities.

### Local Color-Line Model

Natural environments are typically composed of distinct objects, each with its own surface reflectance properties. Modeling natural images as a collage of projected surfaces showed success in matching various empirical statistics. Motivated by these findings we assume that many small image patches correspond to mono-chromatic surfaces and admit the following factorization of the scene radiance

J(x)=l(x)R̅, xεΩ (2)

where R̅ is an RGB vector describing the relative intensity of each color channel of the reflected light, i.e., ∥R̅∥=l. The scalar l(x) describes the magnitude of the radiance at each pixel x in the patch. This assumption is successfully used in various dehazing methods. While this model applies to more general surfaces, in case of purely diffuse surfaces R̅ corresponds to the surface reflectance coefficients and l to the incident light projected onto the surface. For simplicity we refer to R̅ as the surface reflectance or albedo and to l as the shading.

Natural environments are further characterized by being composed of nearly-planar object surfaces. This analogous collage description is also supported by studies of range images and optical flow fields. In addition, the density of dust, water droplets and other aerosols varies smoothly in space due to diffusion processes that govern these particles. The combined effect of these regularities is inherited by the scene transmission due to the following relation:

t(x)=exp(−∫₀^{d(x)}β(rₓ(s))ds), (3)

where d(x) is the depth and rₓ(s) parametrizes the ray at pixel x. The function β(·) denotes the scattering coefficient (in three dimensional space).

Thus, since we expect piecewise smooth scene depths d and a smooth aerosol density, which in turn leads to a smooth scattering coefficient β, the rule of function composition implies that the resulting transmission t(x) is also piecewise smooth function which is smooth at pixels that correspond to the same object.

In order to estimate this assumption statistically we generated transmission maps from outdoor depth maps, by assuming a constant scattering coefficient.

FIG. 1 is a high level flowchart illustrating a method 100 for single-image dehazing in accordance with embodiments of the present invention. Method 100 may include the following steps: dividing a natural image which include haze, into a plurality of image patches, wherein the image patches are sufficiently small so that pixels of the image patches exhibit one dimensional distributions in RGB color space, denoted color-lines 110; generating local image formation models for the pixels of the plurality of image patches, respectively, based on a relationship between the color-lines and the haze 120; calculating an offset of the color-lines from origin point of the respective local image formation models, for the image patches 130; and estimating scene transmission of the natural image, based on the calculated offsets 140.

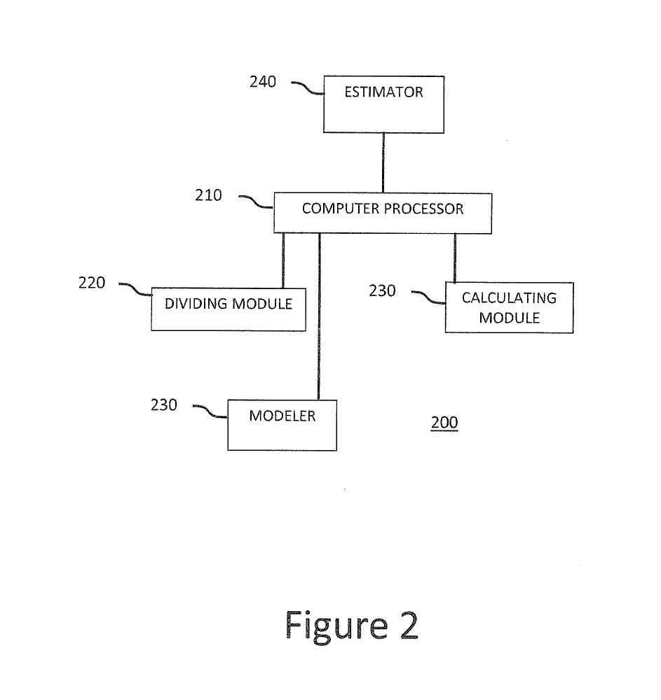

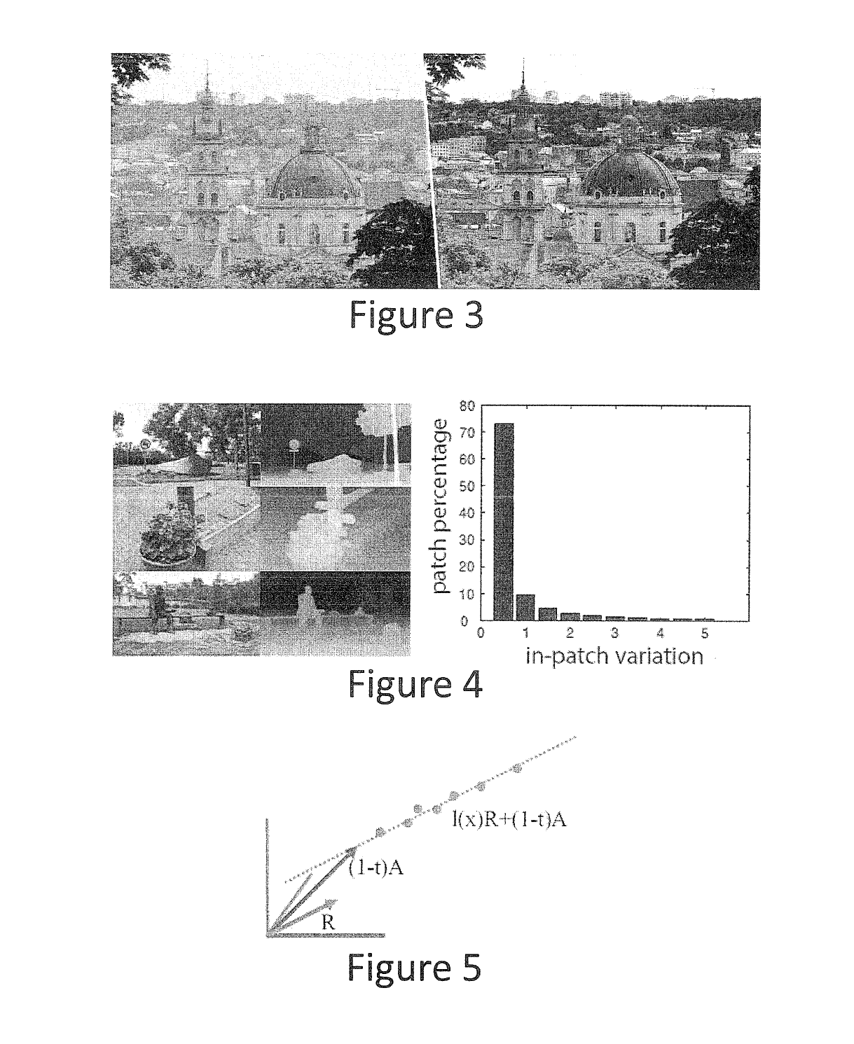

FIG. 2 is a block diagram illustrating a system 200 in accordance with embodiments of the present invention. The system may include a computer processor 210 and several software modules executed thereon as follows: a dividing module 220 configured to divide a natural image which include haze, into a plurality of image patches, wherein the image patches are sufficiently small so that pixels of the image patches exhibit one dimensional distributions in RGB color space, denoted color-lines; a modeler 230 configured to generate local image formation models for the pixels of the plurality of image patches, respectively, based on a relationship between the color-lines and the haze; a calculation module 240 configured to calculate an offset of the color-lines in the image patches from an origin point of the respective local image formation models; and an estimator 250 configured to recover scene transmission of the natural image, based on the calculated offsets.

FIG. 4 shows that in 72% of the images' patches the transmission does not vary from its average by more than 0.5%, |t−t̅|/t<0:05 where t̅ is the average transmission in the patch, and that in 82.5% of the patches the variation is below 1%.

By taking into account both the transmission smoothness with the surface albedo constancy we use the following models to describe small image patches:

l(x)=tl(x)R̅+(l−t)A=l(x)R+(l−t)A, xεΩ (4)

where t is a fixed transmission value in the patch Ω and R=tR. Pixels of a patch Ω obeying this model differ only by the surface shading l(x).

Thus, their values {I(x): xεΩ} are distributed along a one-dimensional line in RGB space. This patch color-line is parameterized by the pixel shading l, its orientation coincides with the patch albedo R, and it is shifted from the origin by the airlight contribution, (l−t)A. This configuration is illustrated in FIG. 5. Studies of haze-free natural images report the existence of color lines in RGB space, however, unlike our scenario these lines pass through the origin.

### Model Validation

The formation model in Eq. (4) does not apply for every image patch. For example, it is highly unlikely that both the albedo and depth (and hence the transmission) will be smooth in patches containing a boundary between different objects. Thus, the unique linear pixel distribution in RGB space predicted by our model makes it possible to identify and discard patches that do not obey it. Herein below various criteria are described, derived from Eq. (4), that pruning patches is uses.

This is in contrast to existing approaches, where no verification of the model validity is made. More specifically, it is always possible to find an airlight-albedo separation that results in zero-correlation and, similarly, every non-negative value is a valid dark-channel value, whether it is produced solely by the airlight or not. In the section below ability to verify the assumptions made over the image plays a central role in the overall robustness and accuracy of the method are being checked. This is being followed by explaining how the transmission is estimated from the color-line model in patches where valid lines are found.

### Transmission Estimation

In the next section we describe the way we recover color-lines inside small image patches and assume here that the line found is given by lD+V, where D, VεR³, and lεR³ is now considered as the free line parameter. Thus, given the color-line, we recover the transmission by finding its offset from the origin, which according to Eq. (4), is of length l−t along A (see FIG. 5). More specifically, we search for the offset sεR along A that shifts the line such that is passes through the origin, i.e., there exists lεR such that lD+V−sA=0. This is geometrically equivalent to intersecting the color-line lD+V with the line passing through the origin in the orientation of the atmospheric light vector, sA. In practice we compute this intersection by solving:

min_{l,s}∥lD+V−sA∥², (5)

where we relax the exact geometric operation by a minimization problem that copes with inaccuracies in the estimated D and V (and perhaps A). This quadratic objective is minimized by solving a 2-by-2 linear system (Eq. (10) at the Appendix) which gives s (and l). According to Eq. (4), the patch transmission is given by t=l−s. This value is expected to be a physically-consistent estimate in patches with approximately constant surface albedo and transmission.

### Relation to Existing Methods

As we mentioned earlier, some publication known in the art estimate a constant layer of haze based on an expected proportionality between the local sample mean and the standard deviation of the pixel intensities. This proportionality is also predicted by our color-line model, and its bias can be estimated by the procedure we describe here. However, unlike the model used above, localized patch-based model of embodiments according to the invention allows us to estimate a spatially-varying scene transmission.

One publication models the pixel histogram using ellipsoids, computed using principal-component analysis. The scene transmission is estimated as the one that minimizes the centroid of the dehazed color ellipsoid, i.e., by searching for the darkest image on average. Unlike our local color-line model the ellipsoid axes do not directly participate in this process and the transmission is not recovered from their offset from the origin. Thus, the two methods follow different assumptions and consist of different transmission estimation procedures.

### Dehazing Algorithm

In this section we explain the steps that we carry out in order to dehaze an image using the local patch model in Eq. (4) and its associated transmission estimation procedure in Eq. (5). We begin with a brief overview of the algorithm. An outer loop of the algorithm scans the input image and considers small windows of pixels as candidate patches that obey Eq. (4). As discussed in the previous section, pixels that correspond to a nearly-planar mono-chromatic surface lie on a color-line in RGB space described by Eq. (4). Therefore, in each patch we run a RANSAC procedure that searches for a line supported by a significant number of pixels. We then check whether the line found is consistent with our formation model by testing it against a list of conditions posed by the model. A line that passes all these tests successfully is then used for estimating the transmission according to Eq. (5). The resulting value then is assigned to all the pixels that support the color-line found. We do not estimate the transmission in patches where we fail to find a line that meets all the conditions. Thus, it is likely that not all the image pixels receive a transmission estimate.

At the last step of the algorithm, we interpolate and regularize the transmission over the entire image using a dedicated Gauss-Markov random field model. Given the complete transmission map, we recover the output image J from I according to Eq. (1). We proceed by describing each of these steps and provide the details of our implementation. The parameter values quoted here apply for images with pixels values between zero and one.

Image Scan. Estimating the transmission at every possible image window is costly and redundant due to their overlap. We use a procedure that limits the number of overlapping transmission estimations while attempting to achieve a uniform coverage of the image. The idea is to scan a non-overlapping grid of square patches that cover the entire image and, since some patches are likely to be discarded, this process is repeated at different grid offsets. In this process we keep track of the number of transmission estimates obtained at each pixel and skip patches in which the center pixel received enough estimates (three or more in our implementation). Multiple times and less work is performed in other regions. In our implementation we use patches of 7-by-7 pixels and scan the image four times by offsetting the grids by half the patch size, 3 pixels at each axis.

### Color-Line Recovery

The color-line are being estimated robustly using RANSAC procedure. This process consists of picking random pairs of pixels in a patch (30 in our implementation), counting the number of patch pixels that lie close to the color-line defined by each pair, and picking the line that receives the largest number of supporting pixels. Then, we check whether the color-line found is consistent with our formation model by running it through a list of accept/reject tests. In case the line passes all the tests, it is used for estimating the transmission over the supporting pixels in the patch. More formally, given two pixels, x₁, x₂εΩ, randomly selected from a patch Ω, we consider the candidate line lD+V defined by

D=I(x₂)−I(x₁), and V=I(x₁). (6)

Each line is associated with pixels xεΩ that support it, i.e., pixels in which I(x) is sufficiently close to the line. This is measured by projecting I(x)−V onto the plane perpendicular to D and computing the norm of the projected vector. In out implementation we associate a pixel with the line if the norm falls below 2×10⁻². In order for this line to be considered as the patch's color-line we require it to meet each of the following conditions.

### Significant Line Support

A small number of supporting pixels implies that either the line fails to represent the patch pixels or that most of its pixels do not obey Eq. (4) as its underlying assumptions do not hold. Therefore, we discard lines with less than 40% pixel support in the patch. If the line passes this test, we redefine the set of patch pixels to be the subset of pixels that support it and do not consider the rest of the pixels in the following tests.

The description below predicts a unique behavior over the patch pixels and the line on which they lie. Not every line found is consistent with this model and hence we apply the following tests to identify and reject lines that cannot be reasoned by our model.

### Positive Reflectance

The color-line orientation D, as discussed herein, corresponds to the surface reflectance vector R in Eq. (4). Therefore, we discard lines in which negative values are found in its orientation vector D. More precisely, since we obtain D up to an arbitrary factor, we identify this inconsistency when D's show mixed signs.

### Large Intersection Angle

The operation of computing the intersection of two lines, as we do in Eq. (5), becomes more sensitive to noise as their orientation gets closer. At the Appendix we show that the error in the estimated transmission grows like O(θ⁻¹), where _{—} is the angle between the line orientation D and atmospheric light vector A. Thus, we discard lines with θ⁻<15° and weigh the confidence of the estimated transmission accordingly when interpolating these values to a complete transmission map (explained below).

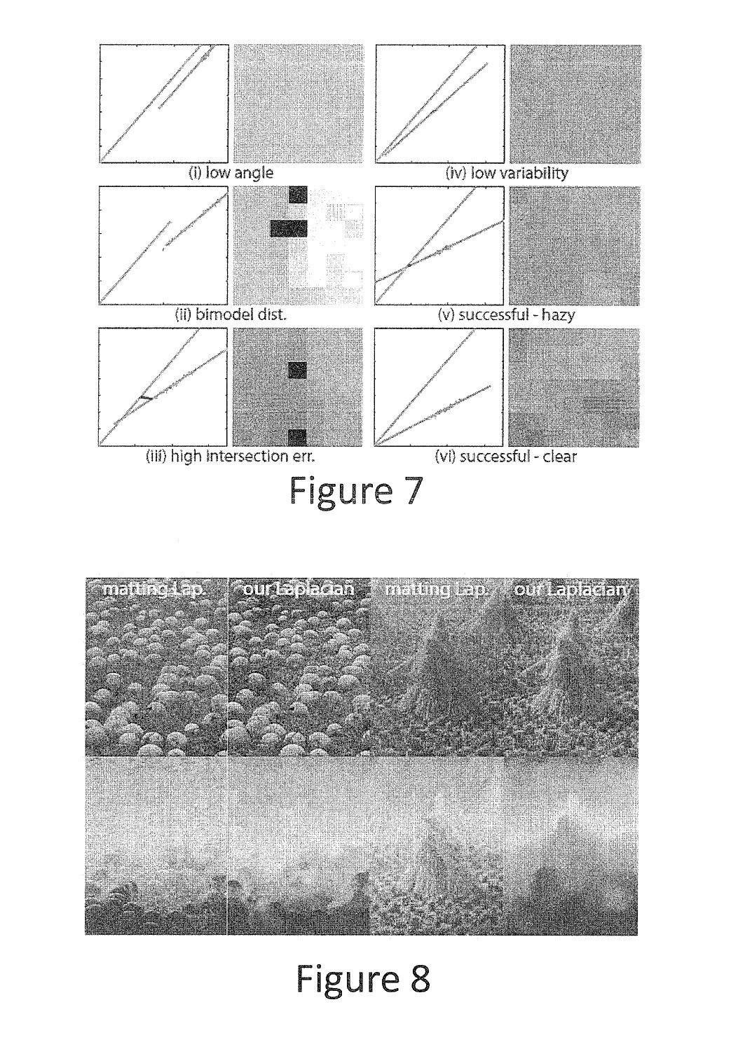

FIG. 7 shows an example of patches with small and large intersection angles. Unimodality. According to the collage model, discussed in Section 3.2, the image is expected to be made of pixels that correspond to piecewise nearly-planar mono-chromatic surfaces. The window patches we are examining may contain interfaces between two or more surfaces (edges in the image). It may be the case that in such patches a line connecting the two clusters of pixels will be proposed, however these pixels cannot be reasoned by Eq. (4) and the line must be rejected. We identify these cases by examining the modality of the pixels' distribution along the line found by computing:

$$\frac{1}{\vert Ω \vert} {\sum }_{x ∈ Ω} cos ( a 〈 I ( x ) - V , D 〉 + b ) , \qquad ( 7 )$$

where the scalars a and b are set to shift and stretch the line parameters [symbol] I(x)−V, D [symbol] of the patch pixels such that their extents coincide with the interval [0; 2π]. The (·,·) denotes the dot-product in RGB space. This measure consists of projecting the line parameters onto a function which is positive at the two ends, 0 and 2π, and negative in the middle (third Fourier mode). Therefore, Eq. (7) vanishes over uniformly distributed pixels and becomes positive when the pixels are concentrated near the endpoints. In our implementation we discard lines in which this value is above 7×10⁻². Close intersection. Eq. (5) searches for a point on the airlight line and a point on the color-line which are closest to one another.

While two arbitrary lines in three-dimensional space do not necessarily intersect, the lines predicted by our model are expected to do so. This requirement introduces another line admissibility test; we discard lines that produce intersection error, i.e., a minimal value in Eq. (5), which is above 5 x¹⁰⁻².

Valid transmission. Similarly, the intersection computed by solving Eq. (5) may not result in a valid transmission value, 0≦t≦1.

Thus, we discard patches in which the intersection results in values outside this admissible range.

Sufficient shading variability. As noted above, the color-line is parameterized by the shading of each pixel, l(x). Thus, the variability in the shading within the patch determines the length of the segment occupied by its pixels along the color-line. In presence of noise, the shorter this segment is, the less reliable the estimated line orientation D becomes. Thus, in principle it is preferable to discard patches whose pixels occupy very short segments.

It is noted however that the segment length also depends intrinsically on the transmission in the patch since the latter multiplies the shading in Eq. (4). This means that the lower the transmission is, the shorter this segment becomes. Thus, in our decision of whether to use or discard a patch, we measure the segment length with respect to the transmission estimated from it. We ensure this self-consistency by computing the standard deviation of the line parameters normalized by the estimated patch transmission value,

\sqrt{Var_{Ω}[ [symbol] I(x)−V,D [symbol] ]}/t, (8)

where Vₐᵣ denotes the empirical variance, computed from the patch pixels. In our implementation we discard the patch if this value fall below 2×10⁻².

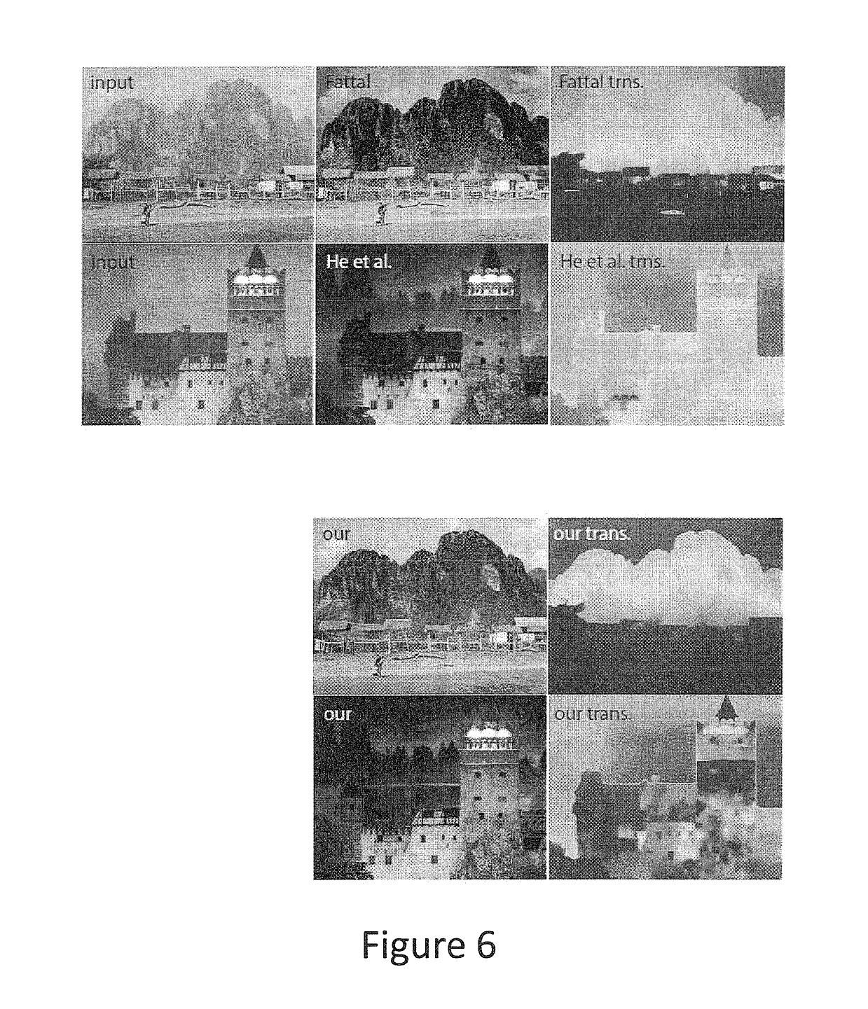

FIG. 5 shows example color-lines that fail some of these tests as well as ones that succeed in estimating t. As discussed in Section 3.2, existing methods do not verify their assumptions and may therefore obtain wrong estimations. FIG. 6 demonstrates this in relation to the previously available dehazing methods. The former underestimates the transmission both at the mountains and transmission values obtained are as low as the sky's). Our method rejects the roof's patches due to the small-angle condition and achieves more accurate results. Once again, these biases are confirmed by inspecting the transmission maps where the method of He et al. produces highly-varying estimates across the castle's pixels which share roughly the same distance from the camera. The over-corrected pixels correspond to the lower transmission values estimated (color-coded in green).

### Transmission Interpolation and Regularization

While the procedure described above typically manages to resolve the transmission over a fairly large portion of the image pixels, there still remains a significant number of pixels where it fails to provide an estimate. Moreover, the list of conditions used to prune patches are necessary, but not enough to guarantee that the line found obeys the suggested model. Therefore, a complete transmission map is obtained and cope with errors due to noise and modeling inaccuracies by applying a Laplacian-based interpolation and regularization step to which is fed to the partially estimated transmission values \hat{t}(x) obtained at the previous step.

This regularization is based on imposing the smoothness of the input image I(x) over the output transmission map t(x) by maximizing the following Gauss-Markov random field (GMRF) model

$$P ( t ) ∝ exp ( - {\sum }_{Ω} {\sum }_{x ∈ Ω} \frac{{( t ( x ) - \hat{t} ( Ω ) )}^{2}}{{( {σ}_{t} ( Ω ) )}^{2}} - {\sum }_{x} {\sum }_{y ∈ {N}_{x}} \frac{{( t ( x ) - t ( y ) )}^{2}}{{‖ I ( x ) - I ( y ) ‖}^{2}} ) . \qquad ( 9 )$$

where Ω runs over all the patches in which a transmission estimate \hat{t}(Ω) is available, and Nx denotes the set of four-nearest neighbors of each pixel x in the image.

The data term, left sum in Eq. (9), results from modeling the error in the estimated transmission as Gaussian noise with variance, σₜ(Ω), which expresses the amount of uncertainly in the estimated values. In the Appendix incorporated at the end of the detailed description derive this model by assuming that the error in the estimated color-line (due to noise in the input pixels) is a zero-mean Gaussian variable with variance σ², and obtain that σₜ(Ω)=σ∥A−D [symbol] D,A [symbol] ∥(1− [symbol] ,A [symbol] ²)⁻¹. The pixel noise level σ can be tuned in case of known acquisition conditions such as ISO setting, aperture size and exposure time. The regularization term, right sum in Eq. (9), penalizes for variation in t(x) according to the smoothness modulus of I(x), i.e., the lower ∥I(x)−I(y)∥² is, the stronger the requirement for low (t(x)−t(y))² becomes. This requirement follows from the fact that according to the haze formation model in Eq. (1), spatial variations in both t(x) and J(x) produce variations in I(x). Hence, the smoothness of I(x) can be used as an upper-bound for that of t(x). In summary, this regularization term allows the transmission map to exhibit sharp profiles along edges in the input image and requires it to be smooth where the input is smooth.

It should be noted that the competition between the smoothness and data terms is strong only at pixels where a reliable transmission estimate is available (small σₜ). This competition gets weaker where the estimates are less reliable and it vanishes where no estimates are available, in which case the MRF acts as a pure interpolation mechanism.

Maximizing P is done by minimizing the quadratic form −log P which boils down to solving a linear system consisting of a sparse Laplacian matrix with strictly negative off-diagonal elements (known as M-matrix). In contrast the matting Laplacian.

In principle, this behavior follows from the fact that the matting Laplacian is derived under the assumption of linear relation between the transmission (alpha-channel in the original context) and the input pixels I(x), meaning that small variations in the latter will induce variations in the former. Images are intrinsically more content-rich compared to transmission maps, mainly due to changes in the surface shading and albedo. Attributing these variations to the transmission leads to their unwanted reduction in the dehazed image J. FIG. 8 shows the contrast reduction created by using the matting Laplacian for regularization. The regularization term in Eq. (9) couples nearby pixels and is responsible for the interpolation of the transmission to pixels x lacking their own estimate, \hat{t}(x). However, occasionally there are islands of strongly-connected pixels which are weakly connected to their surrounding pixels due to color mismatch, i.e., large ∥I(x)−I(y)∥² in the denominator of the regularization term in Eq. (9). This scenario takes place between pixels of distinct objects.

In case no transmission estimate exists inside the island, its pixels may receive irrelevant values from their surrounding pixels which correspond to a different object in the scene. We avoid these wrong assignments by searching for similar pixels within a wider perimeter and augmenting Nₓ with these additional coordinates.

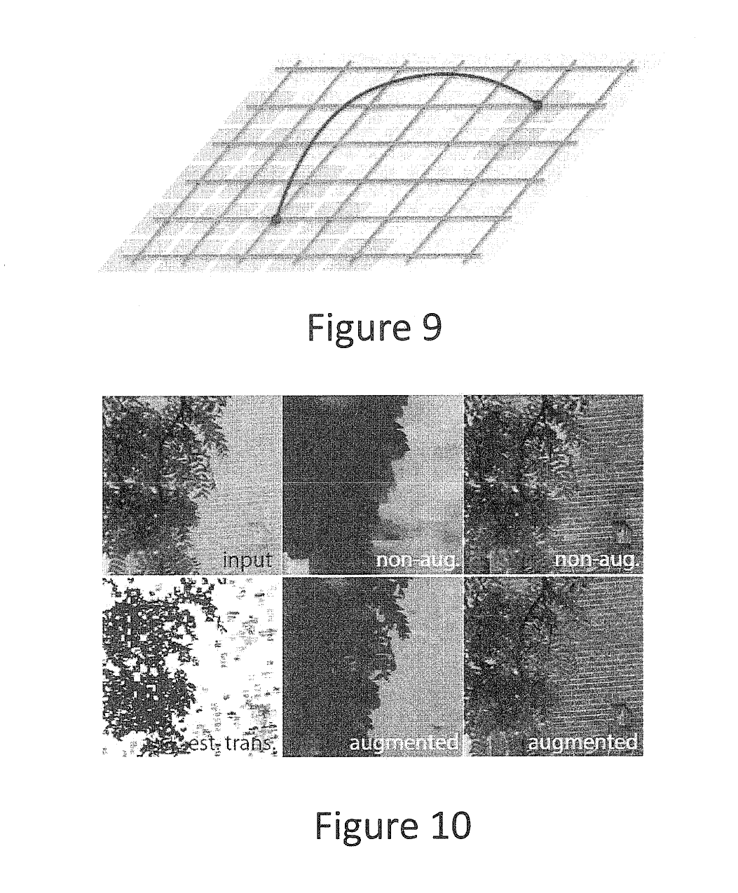

This augmented GMRF is illustrated in FIG. 9. In our implementation, we find these connections by randomly sampling pixels y inside windows whose size is 15% of the image size and once we find a pixel y such that ∥I(x)−I(y)∥<0:1 we stop the search and add it to Nₓ. For efficiency reasons we stop the search after five unsuccessful attempts and limit this augmentation to a subsampled grid of every fourth pixel in each image axis. Hence, this process increases the number of connections by a small factor of 1/64 and increases the GMRF construction and solve time by less than 25%. Note that since we do not perform a complete search within these windows but use few random samples, this procedure does not undermine the overall linear running time of our algorithm. We note that the use of long-range connections was explored in the context of image denoising for capturing high-order relations efficiently in one publication.

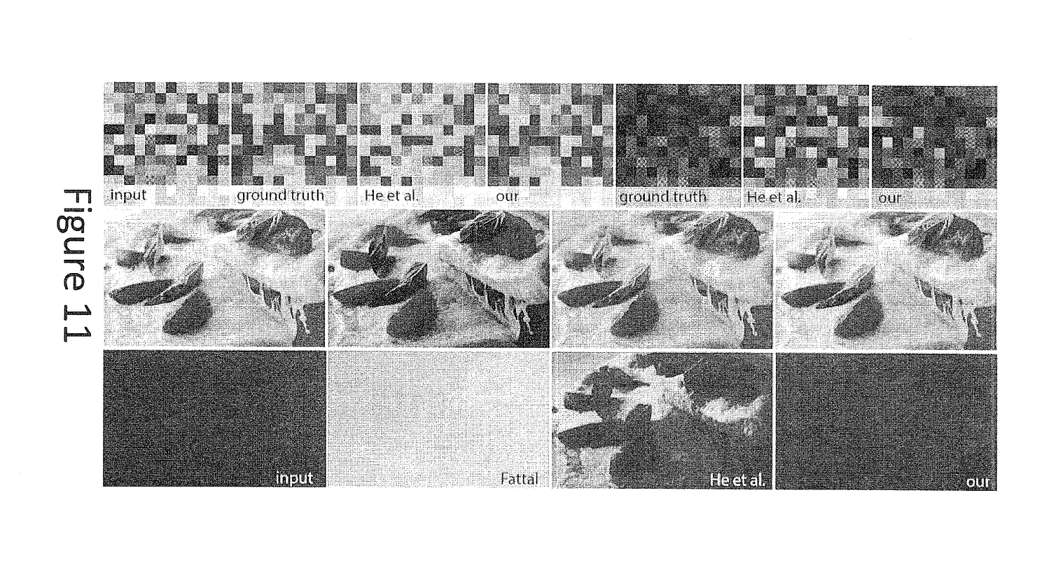

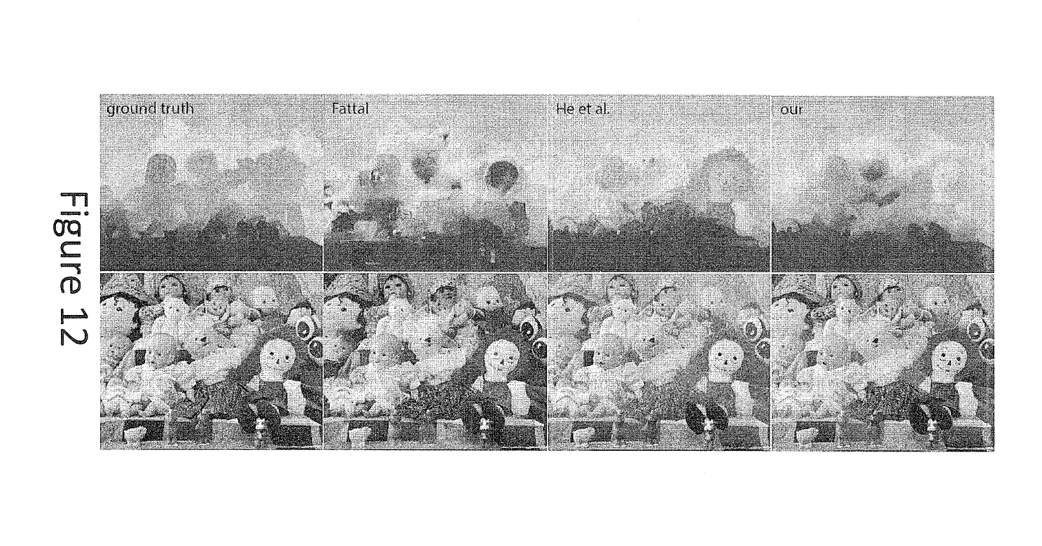

Finding a small number of long-range connections is enough to resolve all the island's pixels due to their strong inner connectivity and weak dependency on the surrounding. FIG. 10 shows how the transmission in regions surrounded by tree leafs is resolved better by the augmented GMRF.

### Results

We report here the evaluation of our method over a large dataset of over 40 images that includes the benchmark images used by previous dehazing algorithms to evaluate their methods. All the tests shown in the paper as well as many other can be found in the supplemental material1. We strongly encourage the reader to explore this in-depth comparison.

The images generated by our method were produced by the same set of parameters quoted in the previous sections. The thresholds were determined by a learning procedure in which we searched for the optimal values that achieve the highest accuracy over a set of three images with known ground-truth transmission (Road1, Flower1, and Lawn1). We used the fixed value of σ= 1/30 to produce all our dehazed images even through they arrived from multiple sources with unknown noise level. Finally, we applied our method with the atmospheric light vectors A used by others (depending on the source of the image), and when unavailable we recovered this value by manually selecting the haziest pixel in the image. The values of the atmospheric light vectors A that we used are specified in the supplemental material.

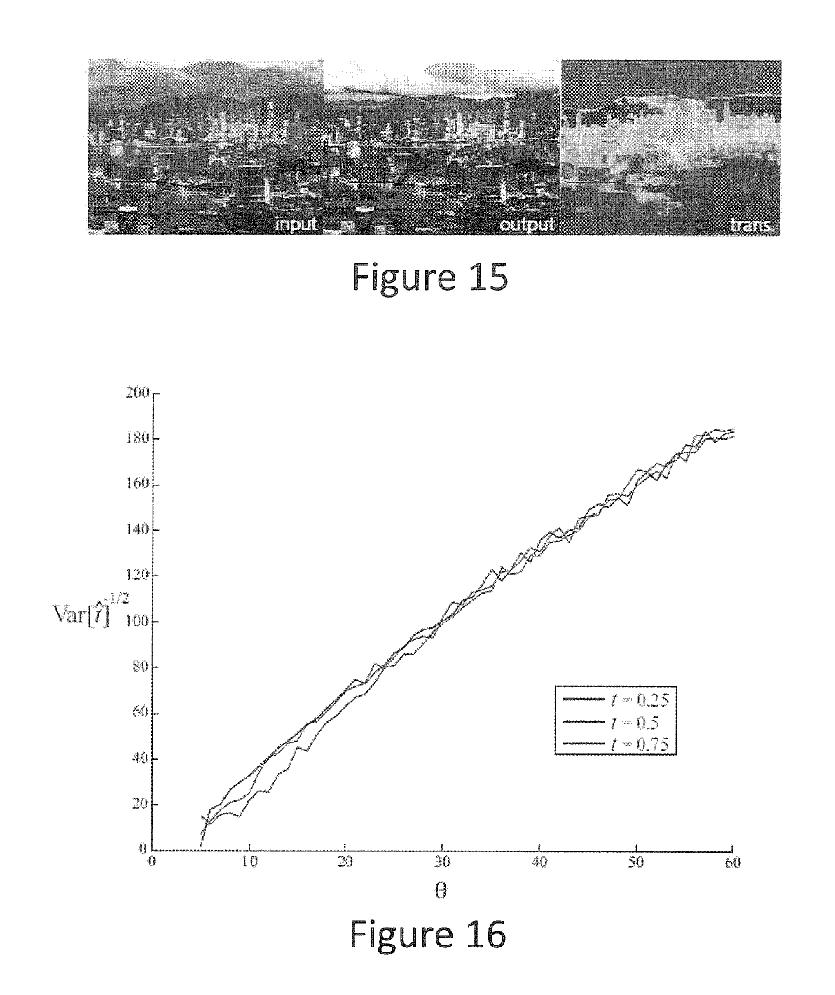

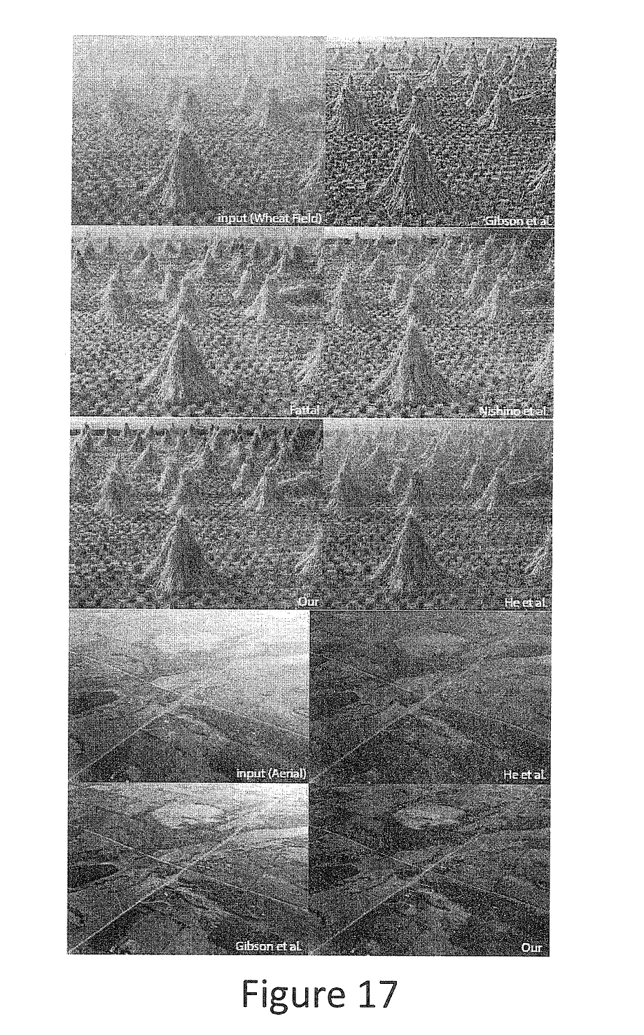

Qualitative comparison. FIG. 15 and FIG. 17 show a number of the comparisons we made against state-of-heart methods where several trends can be pointed out. The method of produces results of variable quality, suffering from occasional severe over- and under-estimations in the transmission.

This can be attributed to its inability to validate its assumptions and its limited operation across the image due to a conservative signal-to-noise criterion. These failures are seen in the Red Bricks House image where it over corrects the red bricks and under corrects the grass as well as in the false variations it produces in the Stadium image (see supp. mat.). Moreover, this approach shows a limited ability to dehaze distant regions in the Wheat Field, Aerial and Manhattan images. A severe over-correction is seen in the Mountain image shown in FIG. 6.

As pointed out earlier while the method removes haze robustly, it also tends to underestimate the transmission and produce over-saturated results, see for example the Manhattan and Red Bricks House images. A somewhat similar behavior is seen in the Red Bricks House and Swan images dehazed by one publication which over corrects the bricks and swans.

One known dehazing process is known for its robustness. However, in regions where no color channel vanishes it underestimates the transmission and also produces over-corrected results, as seen in FIG. 6. As discussed herein above, the matting Laplacian regularization in one publication use transfers some of the fine image detail into the transmission. This leads to an overall reduction of contrast in J(x) which can be observed at the distant regions of the Cityscape, Hong Kong, Manhattan, Snow Mountain and Wheat

Field images as well as in the Logos and Red Bricks House. In the supplemental material we compare between the transmission maps generated by the different methods.

Finally, the method of one embodiment produces well-balanced results with some under performance at heavily hazed regions. We should note however that unlike the rest of the methods mentioned here, this method requires a user-aligned scene geometry.

Similarly to the rest of the methods, our method has a limited effectiveness at regions of very low visibility such as in the case of Staten Island seen in the Manhattan image. The amplification of noise at these regions is another noticeable drawback. However, in most cases it compares favorably to the alternatives in this respect.

Quantitative comparison. In order to quantitatively evaluate the performance of our method we tested it over different types of images in which the transmission is known. In the first test we synthesized artificial scenes composed of distinct squares where we randomly sampled the reflectance coefficients, illumination function and a constant transmission value and plugged these values in Eq. (4) to simulate haze. We used this procedure twice and in the second image we generated (the DC Squares) we made sure that, when sampling the reflectance values, at least one channel is set to zero in order to meet the dark-channel prior as well. The images produced in this test are shown in FIG. 11 as well as the results obtained by other method and our method. The L1 errors produced on both images (with and without the dark-channel constraint) are reported in Table I.

TABLE I
Accuracy comparison with known ground-truth.

| | Fattal [2008] | He et al. [2009] | our |
|---|---|---|---|
| Squares | 0.083/0.097 | 0.11/0.15 | 0.03/0.06 |
| DC Sqrs. | 0.056/0.061 | 0.115/0.17 | 0.025/0.05 |
| Pizza | 0.42/0.21 | 0.164/0.073 | 0.0255/0.012 |
| Fruit | 0.171/0.064 | 0.011/0.016 | 0.0025/0.003 |

In another test we applied different dehazing methods over lucid, haze-free, images in which case we expect t(x)=1 to be the solution. FIG. 11 shows one of these images and Table I provides the errors produced by older methods.

and ours. In both tests our method outperforms the competing techniques.

All the images participating in the tests detailed in this section can be found at the supplemental material. In order to obtain a more realistic evaluation we synthesized hazy images of natural scenes using pairs of real-world photographs and their corresponding depth maps. By assuming the media scattering coefficient β is constant in space, we obtain the transmission from Eq. (3) by t(x)=e^{-βd(x)}, where d(x) is the optical depth at each pixel x. Note that the resulting transmission maps are not constant in image space and exhibit non-trivial variations along depth discontinuities. We produced 12 such test images using the depth maps found in in previous dehazers and uses them to compare our method with the methods. FIG. 12 shows the results obtained over one of these test image. Table II summarizes the L1 errors in the estimated transmission and dehazed image J(x) produced by the different methods. In this test our method achieves the highest accuracy.

TABLE II
Accuracy comparison over real-world images with known transmission.

| | Fattal [2008] | He et al. [2009] | our |
|---|---|---|---|
| Road1 | 0.319/0.078 | 0.097/0.032 | 0.069/0.020 |
| Road2 | 0.347/0.096 | 0.086/0.026 | 0.061/0.019 |
| Flower1 | 0.089/0.017 | 0.190/0.065 | 0.047/0.012 |
| Flower2 | 0.074/0.013 | 0.203/0.058 | 0.042/0.009 |
| Lawn1 | 0.317/0.053 | 0.118/0.030 | 0.078/0.015 |
| Lawn2 | 0.323/0.061 | 0.115/0.034 | 0.064/0.015 |
| Mansion | 0.147/0.044 | 0.074/0.030 | 0.042/0.015 |
| Church | 0.377/0.105 | 0.070/0.033 | 0.038/0.018 |
| Couch | 0.089/0.020 | 0.069/0.019 | 0.089/0.019 |
| Dolls | 0.043/0.068 | 0.036/0.055 | 0.031/0.046 |
| Moebius | 0.111/0.027 | 0.235/0.091 | 0.145/0.047 |
| Reindeer | 0.070/0.018 | 0.126/0.043 | 0.066/0.015 |

We further used these images for gathering the statistics reported in FIG. 2, as well as for studying the sensitivity of the three methods to the level of noise and the thickness of the haze present in the image.

Table III reports the errors obtained over sequences of images produced with an increasing level of scattering coefficient (three levels of β differing by a factor of 3). As β increases and the haze becomes thicker, some previous methods loses accuracy both in its transmission estimate and dehazed output J(x). In contrast, some other method and method according to some embodiments estimate the transmission more accurately at higher β values.

TABLE III
Sensitivity to scattering level over real-world
images with known transmission

| scattering | Fattal [2008] | He [2009] | our |
|---|---|---|---|
| Road1 | | | |
| low | 0.083/0.019 | 0.122/0.029 | 0.075/0.017 |
| medium | 0.319/0.078 | 0.097/0.032 | 0.070/0.020 |
| high | 0.604/0.150 | 0.055/0.039 | 0.043/0.024 |
| Lawn1 | | | |
| low | 0.104/0.019 | 0.158/0.030 | 0.040/0.009 |
| medium | 0.317/0.053 | 0.118/0.030 | 0.076/0.015 |
| high | 0.442/0.090 | 0.064/0.034 | 0.050/0.017 |
| Mansion | | | |
| low | 0.033/0.009 | 0.108/0.031 | 0.040/0.010 |
| medium | 0.147/0.044 | 0.074/0.030 | 0.042/0.015 |
| high | 0.533/0.153 | 0.039/0.031 | 0.029/0.022 |
| Church | | | |
| low | 0.079/0.022 | 0.148/0.039 | 0.045/0.013 |
| medium | 0.377/0.105 | 0.070/0.033 | 0.036/0.017 |
| high | 0.771/0.193 | 0.027/0.032 | 0.023/0.027 |
| Reindeer | | | |
| low | 0.018/0.004 | 0.150/0.042 | 0.057/0.013 |
| medium | 0.070/0.018 | 0.126/0.043 | 0.067/0.016 |
| high | 0.303/0.082 | 0.072/0.044 | 0.053/0.023 |

The increase in the transmission accuracy can be explained by the reduction in the contribution of the direct transmission, t(x)J(x) in Eq. (1). The latter is the (sole) component in which inaccuracies in the dark-channel assumption can appear. In case of our method, pixels of heavily-hazed patches cluster closer to the atmospheric light line, sA, and hence the intersection point between this line and the patch color-line is less sensitive to errors in the recovered color-line orientation vector D. Nevertheless, in both cases the increased accuracy of t(x) does not lead to higher accuracy in the dehazed image J(x). This follows from the more extreme correction involved in removing thick layers of haze when extracting J(x) from Eq. (1).

In order to assess the influence of noise, we added an identically distributed zero-mean Gaussian noise to each color channel of each image pixel independently. This test was conducted with three different noise levels, σ=0:01; 0:025 and 0:05.

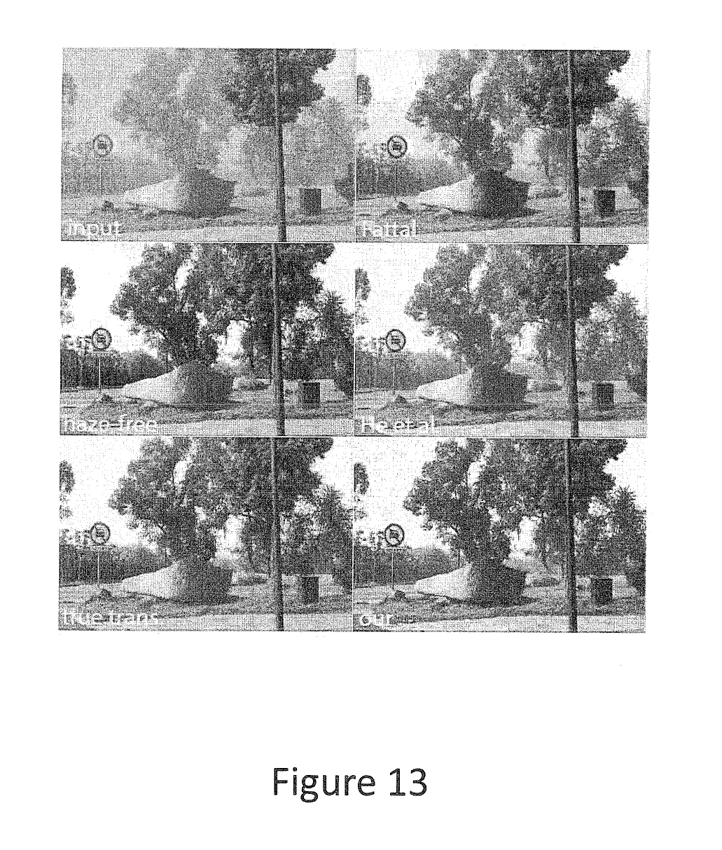

FIG. 13 shows one of the images used in this test with σ=0:05 where our method managed to achieve stronger dehazing in the farther regions of the scene. However, there are regions in this image where our method under-estimated the transmission and, by subtracting the blueish haze, resulted in unnatural yellowish output (such as in the case of the distance trees). Two color channel images. Finally, while the method according to embodiments of the present invention is derived for three color-channel images, most of the derivation holds for two-channel images including the line intersection formula in Eq. (5). The lack-of-intersection criterion, however, trivializes as every two non-parallel lines intersect in two-dimensional space.

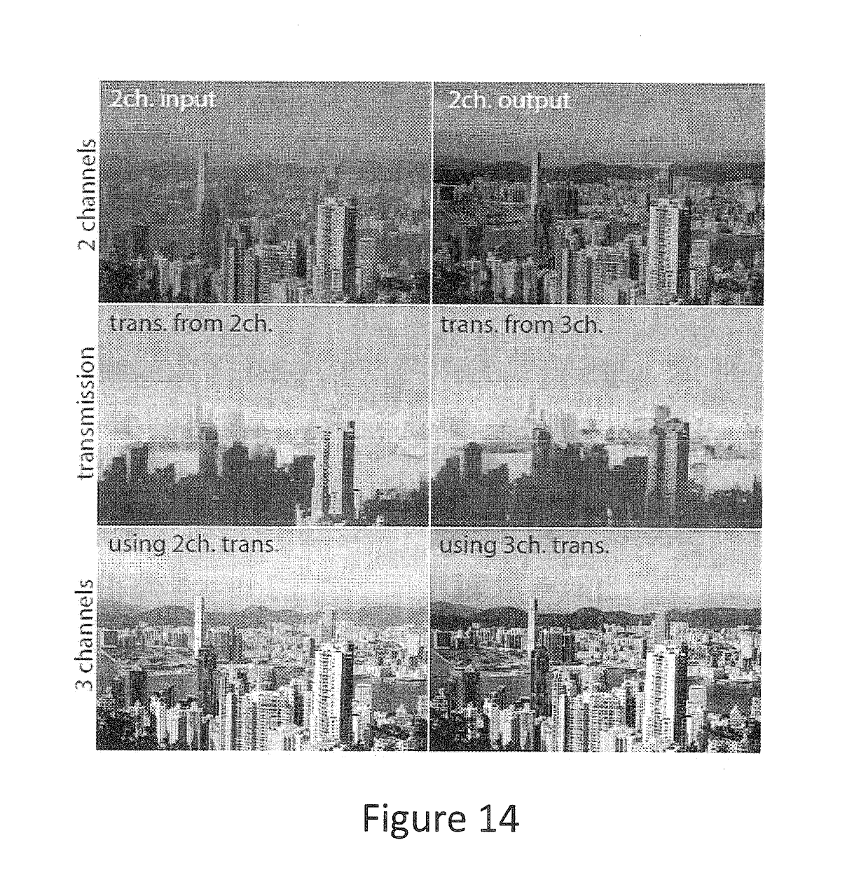

FIG. 14 shows the result obtained when we evaluate the transmission based on two channels by dropping the red channel of the Hong Kong image. While there is a some over-estimation in the recovered transmission, the method remains effective for two color channel images.

### Running Times

The inventors have implemented the method according to embodiments of the present invention in C and run it on a 2.6 GHz computer (running on a single core). Estimating the transmission in a one mega-pixel image takes us 0.4 seconds and constructing and solving the GMRF takes another 5 seconds. Other benchmark dehazing algorithms require 10 to 20 seconds to process a 600×400 pixel image on a 3.0 GHz machine. These longer running times of prior art may be attributed to the construction and solution of the matting Laplacian, which unlike the Laplacian according to embodiments of the present invention, its entries are computed based on patches rather than individual pixels. Moreover, this matrix is not an M-matrix which makes it harder to solve. The edge-avoiding wavelets was shown to accelerate edge-aware interpolation problems with scattered data such as our partial transmission maps. This method was used successfully to compute the transmission and reach an overall running time of 0.55 seconds per one mega-pixel image (0.15 seconds for the interpolation). At the supplemental material we provide several comparisons between the different smoothing methods. While solving the Laplacian system achieves a greater accuracy (mostly on low-resolution images), the tests show that in many cases negligible visual differences are observed. All the time quotes mentioned here grow linearly with the image dimension.

### Conclusions

A new single-image dehazing method was presented herein based on the color-lines pixel regularity in natural images. A local formation model was derived that reasons this regularity in hazy scenes and described how it is used for estimating the scene transmission. Unlike existing dehazing methods that follow their assumptions across the entire image, the new formation model allows us to dismiss parts of the image that violate the underlining assumptions and achieve higher overall accuracy. An augmented GMRF model has been proposed herein with long-range coupling in order to better resolve the transmission in isolated pixels that lack their own estimate. Finally, the results of an extensive evaluation of the algorithms have been reported on different types of problems that demonstrate its high accuracy. Besides practical contributions, at the theoretical level of image understanding, this work supports the relevance of dead-leaves type of models to hazy natural scenes.

### Limitations

Some embodiments of the method according to the present invention rely on specific assumptions based on which we derive Eq. (4). While a list of conditions for identifying patches that do not obey Eq. (4), has been proposed this list is not sufficient to guarantee a correct classification. As an example, FIG. 15 shows a night scene with many artificial colored lights and specular highlights. The transmission estimated in this scene is severely underestimated across the shore of lit buildings which is over-corrected by our method. Furthermore, even when classifying patches correctly we may still obtain too few estimates across the image. We should note however that our reported evaluation demonstrates that the color-line assumption is, in general, a reliable and competitive prior for hazy scenes.

While the method in accordance with embodiments of the present invention achieves higher accuracy in low noise levels (σ<0:01), Table IV shows that at high noise levels σ_{geq}0:05, our method becomes less accurate than competing approaches.

FIG. 14 shows another difficult problem, shared by other dehazing techniques, which is the treatment the sky receive. In many cases the atmospheric light is very close to the sky color and hence the latter is wrongly treated as a thick layer of haze. Finally, unlike some methods known in the art, the method according to embodiments of the present invention cannot operate on mono-chromatic images where the notion of color-lines trivializes.

### APPENDIX

Analyzed herein is the dependency of the error in the estimated transmission on the angle between the patch-line orientation D and the atmospheric light vector A. The transmission is recovered by minimizing Eq. (5), which boils down to solving the following system

$$[ \begin{matrix}{‖ D ‖}^{2} & - 〈 A , D 〉 \\ - 〈 A , D 〉 & {‖ A ‖}^{2}\end{matrix} ] [ \begin{matrix}l \\ s\end{matrix} ] = [ \begin{matrix}- 〈 D , V 〉 \\ 〈 A , V 〉\end{matrix} ] \qquad ( 10 )$$

Since ∥D∥ is chosen arbitrarily let us assume that ∥D∥=∥A∥ and hence, with no loss of generality, let us further assume the two are ∥D∥=∥A∥=1. In this case, the solution for Eq. (10) is given by

$$[ \begin{matrix}l \\ s\end{matrix} ] = \frac{1}{1 - {〈 D , A 〉}^{2}} [ \begin{matrix}1 & 〈 A , D 〉 \\ 〈 A , D 〉 & 1\end{matrix} ] [ \begin{matrix}- 〈 D , V 〉 \\ 〈 A , V 〉\end{matrix} ] \qquad ( 11 )$$

Now the error in the estimated line offset vector is denoted by E, i.e., V=(1−t)A+E. In which case the estimated transmission, \hat{t}=1−s, is given by:

$$1 - \frac{〈 A , ( 1 - t ) A + E 〉 - 〈 D , ( 1 - t ) A + E 〉 〈 D , A 〉}{1 - {〈 D , A 〉}^{2}} = 1 - ( 1 - t ) \frac{1 - {〈 D , A 〉}^{2}}{1 - {〈 D , A 〉}^{2}} + \frac{〈 A , E 〉 - 〈 D , E 〉 〈 D , A 〉}{1 - {〈 D , A 〉}^{2}} , \qquad ( 12 )$$

where the terms besides the last reduce to the true transmission t and the last term corresponds to the estimation error. Note that if E=0 then this error vanishes, meaning that the line may have an arbitrary orientation D and yet the exact transmission t will be recovered. This follows from the fact that we recover the transmission based on the patch-line's offset from the origin.

Having assumed that ∥Ak∥=∥D∥=1 the similarity between the orientation of the two can be measured by the length of Δ=A−D.

Thus, the error term in Eq. (12) becomes

$$\frac{〈 D , E 〉 + 〈 Δ , E 〉 - 〈 D , E 〉 - 〈 D , E 〉 〈 D , Δ 〉}{1 - {( 1 + 〈 D , Δ 〉 )}^{2}} = \frac{〈 Δ , E 〉 - 〈 D , E 〉 〈 D , Δ 〉}{- 2 〈 D , Δ 〉 - {〈 D , Δ 〉}^{2}} . \qquad ( 13 )$$

Now since

1=∥A∥²=∥D+Δ∥²=∥D∥²+2 [symbol] D,Δ [symbol] +∥Δ∥²=1+2 [symbol] D,Δ [symbol] +∥Δ∥² (14)

we get (D, Δ)

, and therefore the transmission error in Eq. (13) is approximately

$$\frac{O ( ‖ Δ ‖ ) - 〈 D , E 〉 O ( {‖ Δ ‖}^{2} )}{O ( {‖ Δ ‖}^{2} ) - O ( {‖ Δ ‖}^{4} )} = O ( {‖ Δ ‖}^{- 1} ) \qquad ( 15 )$$

Finally, since

∥Δ∥²=∥A−D∥²=∥A∥² [symbol] D,A [symbol] +∥D∥²=2+2 cos(θ)≈θ², (16)

for small angle _{—} between the D and A, we conclude that the error in the transmission grows like O(θ⁻¹).

FIG. 15 shows a numerical simulation, where we synthesized patches with colorlines that form different angles with A and added Gaussian noise with σ=0:01. The graphs confirm the prediction of our analysis, namely, that the transmission t estimated from Eq. (12) Var[t]⁻¹=θ².

In practice, we use this transmission estimate to define the Gaussian Markov random field model in Eq. (9) from which we obtain a complete regularized transmission map. In this model we specify the confidence in the estimated values based on the relation between A and D in the corresponding patch. This score is derived by modeling the patch-line error E as a zero-mean Gaussian variable and, since it appears in linear form in the transmission error term (last term in Eq. (12)), we get a zero-mean Gaussian noise in the estimated transmission. More specifically, by rewriting its numerator as [symbol] A−D [symbol] D, A [symbol] , E [symbol] we obtain the following standard deviation in the estimated transmission

$$σ \frac{‖ A - D 〈 D , A 〉 ‖}{1 - {〈 D , A 〉}^{2}} \qquad ( 17 )$$

which we plug in Eq. (9), where a is the standard-deviation of E.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A method for single-image dehazing comprising:
dividing a natural image which includes haze, into a plurality of image patches, wherein the image patches are sufficiently small so that pixels of the image patches exhibit one dimensional distributions in RGB color space, denoted color-lines;
generating local image formation models for the pixels of the plurality of image patches, respectively, based on a relationship between the color-lines and the haze;
calculating an offset of the color-lines from an origin point of the respective local image formation models, for the image patches; and
estimating scene transmission of the natural image, based on the calculated offsets.

2. The method according to claim 1, further comprising identifying patches that do not exhibit proper color-lines and discarding them prior to the estimating.

3. The method according to claim 1, wherein the transmission is estimated under the assumption that the atmospheric light vector is given.

4. The method according to claim 1, wherein the transmission estimations are interpolated and regularized into a complete transmission map using a dedicated Markov random field model.

5. The method according to claim 1, wherein the transmission is recovered in isolated regions where nearby pixels do not offer relevant information by detecting long-range connection with other pixels outside the isolated regions.

6. The method according to claim 1, wherein the generation of the models is carried out for a non-overlapping grid of square patches that cover the entire image and repeating the generation of the models at different grid offsets.

7. A system for single-image dehazing comprising:
a computer processor;
a dividing module configured to divide a natural image which include haze, into a plurality of image patches, wherein the image patches are sufficiently small so that pixels of the image patches exhibit one dimensional distributions in RGB color space, denoted color-lines;
a modeler configured to generate local image formation models for the pixels of the plurality of image patches, respectively, based on a relationship between the color-lines and the haze;
a calculation module configured to calculate an offset of the color-lines in the image patches from an origin point of the respective local image formation models; and
an estimator configured to recover scene transmission of the natural image, based on the calculated offsets,
wherein the dividing module, the modeler, the calculation module, and the estimator are executed by the computer processor.

8. The system according to claim 7, further comprising identifying patches that do not exhibit proper color-lines and discard them prior to the recovering.

9. The system according to claim 7, wherein the transmission is estimated under the assumption that the atmospheric light vector is given.

10. The system according to claim 7, wherein the transmission is recovered by partial estimates that are interpolated and regularized into a complete transmission map using a dedicated Markov random field model.

11. The system according to claim 7, wherein the transmission is recovered in isolated regions where nearby pixels do not offer relevant information by detecting long-range connection with other pixels outside the isolated regions.

12. The system according to claim 7, wherein the generation of the models is carried out for a non-overlapping grid of square patches that cover the entire image and repeating the generation of the models at different grid offsets.
